(19) United States
(12) Patent Application Publication
(10) Pub. No.: US 2020/0105138 A1
(43) Pub. Date: Apr. 2, 2020

(54) VEHICLE TRAVEL INFORMATION GENERATION SYSTEM

(71) Applicant: Honeywell International Inc., Morris Plains, NJ (US)

(72) Inventors: Divya Swarup Giriyappa Srinivasan, Bangalore (IN); Thomas D. Judd, Woodinville, WA (US)

(73) Assignee: Honeywell International Inc., Morris Plains, NJ (US)

(21) Appl. No.: 16/144,053

(22) Filed: Sep. 27, 2018

(51) Int. Cl. G08G 1/0967; G01C 21/34; G05D 1/00; G05D 1/02; G06F 17/30; H04W 4/021; H04W 4/40

(52) U.S. Cl. CPC G08G 1/096725; G01C 21/3461; G05D 1/0088; G05D 2201/0213; G06F 17/30241; H04W 4/021; H04W 4/40; G05D 1/0276

(57) ABSTRACT

A vehicle travel information system that includes at least one database, at least one vehicle location system and at least one processor unit is provided. The at least one processer unit is configured to implement instructions to monitor location information provided by the at least one vehicle location system to determine when the vehicle has at least one of entered a travel region with associated region information and is about to enter a travel region with associated region information. The at least one processor unit is further configured to implement region information instructions stored in the database that is associated with the region information when the vehicle enters or is about to enter a travel region with associated region information. Associated region information includes at least one of alert instructions, report generation instructions, selection instructions, feature instructions and restriction instructions.

### BACKGROUND

An operator of vehicle may need information as the vehicle travels along a travel path. For example, aircraft may need information regarding regulated airspace such as restricted air space, altitude limits, speed limits, etc. encountered through a travel path. The amount of information needed in planning operation of the aircraft through the travel path can be overwhelming. To spread out the information needed, information may be communicated to the aircraft from an air traffic controller (ATC) as the aircraft travels along the travel path through a datalink. Current datalink products used in the avionic industry offer a standard profile for all airlines in terms of user interfaces and features. However, there are limited customization options for airlines to do in aeronautical operational control (AOC) using an airline modifiable information (AMI) database or ART database. For example, there are limits to cost index/DSP selection/subnetwork preferences.

### SUMMARY

The following summary is made by way of example and not by way of limitation. It is merely provided to aid the reader in understanding some of the aspects of the subject matter described. Embodiments provide a vehicle travel information system that generates region specific information instructions stored in an onboard database based on a current location or projected location of the vehicle.

In one embodiment, a vehicle travel information system is provided. The system includes at least one vehicle location system and at least one processor unit. The at least one vehicle location system is configured to generate vehicle location information. The at least one database includes region information associated with select regions of travel. The at least one processor unit is in communication with the at least one vehicle location system. The at least one processer unit is configured to implement instructions to monitor the location information provided by the at least one vehicle location system to determine when the vehicle has at least one of entered a travel region and is about to enter a travel region with associated region information, the at least one processor unit further configured to implement region information instructions associated with the region information when the vehicle has at least one of entered a travel region and is about to enter a travel region with the associated region information, wherein implementing region information instructions includes implementing at least one of alert instructions, report generation instructions, selection instructions, feature instructions and restriction instructions.

In another example embodiment, another vehicle travel information system is provided. The system includes at least one database, at least one vehicle location system, a vehicle user interface and at least one processor unit. The at least one database contains region information. The at least one vehicle location system is configured to generate vehicle location information. The at least one processor unit is in communication with the at least one database, the at least one vehicle location system and vehicle user interface. The at least one processer unit is configured to implement instructions to monitor the location information provided by the at least one vehicle location system to determine when the vehicle has at least one of entered a travel region with associated region information and is about to enter a travel region with associated region information, the at least one processor unit further configured to implement the associated region information when the vehicle has at least one of entered the travel region with the associated region information and is about to enter the travel region with the associated region information to implement at least one of alert instructions, report generation instructions, selection instructions, feature instructions and restriction instructions, the at least one processer further configured to convey the region information via the vehicle user interface.

In yet another embodiment, a method of generating vehicle travel information is provided. The method includes monitoring the current location of the vehicle; based on at least one of the current location of the vehicle in a region and an anticipated location of the vehicle in a region in a near future, determining if at least one of the current location and the anticipated location of the vehicle is associated with a region that has associated region information stored in at least one database; and when it is determined that at least one of the current location and the anticipated location of the vehicle is associated with a region that has associated region information stored in the at least one database, implementing the associated region information to implement at least one of alert instructions, report generation instructions, selection instructions, feature instructions and restriction instructions.

### BRIEF DESCRIPTION OF THE DRAWINGS

Embodiments can be more easily understood and further advantages and uses thereof will be more readily apparent, when considered in view of the detailed description and the following figures in which:

FIG. 1 is a block diagram of a vehicle travel information system according to one exemplary embodiment; and

FIG. 2 is an information generating flow diagram according to one exemplary embodiment.

In accordance with common practice, the various described features are not drawn to scale but are drawn to emphasize specific features relevant to the subject matter described. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the embodiments, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments provide a vehicle travel information system that generates region specific information instructions stored in an onboard database based on a current location or projected location of the vehicle. Moreover, embodiments provide an enhanced customization profile/feature by using real-time vehicle situation parameters, such as but not limited to, position, air/ground, speed, altitude, etc., to dynamically configure and react. Embodiments have alerts/selection/features/restrictions that are database driven profiles. In one embodiment, the profiles may be uplinked to configure settings within one or more databases within the vehicle.

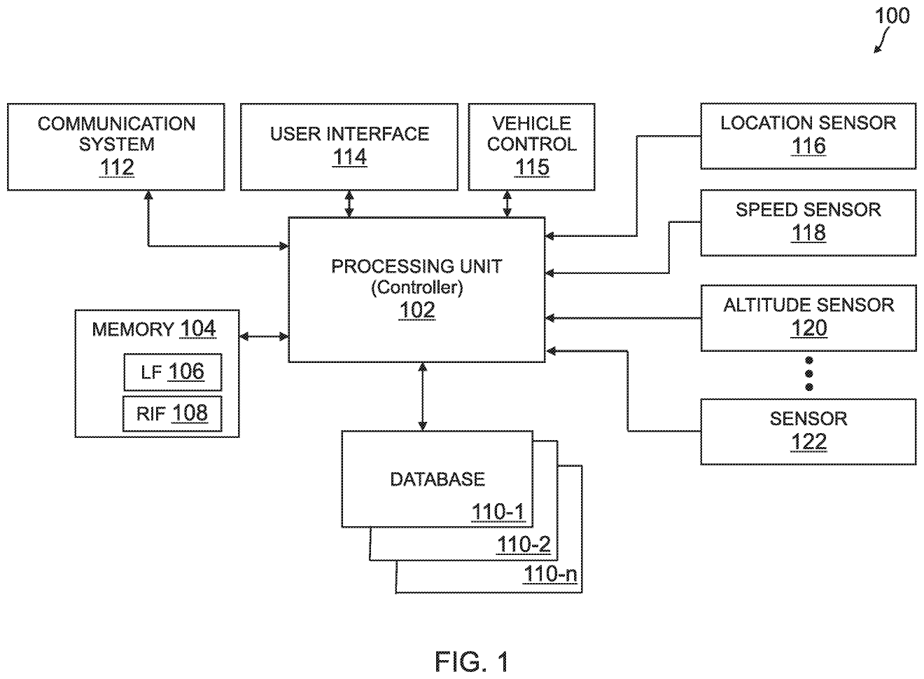

Referring to FIG. 1, a block diagram of a vehicle travel information system 100 of an embodiment is illustrated. This Example embodiment includes a processing unit 102 that implements instructions stored in a memory 104. In general, the processing unit 102 (or controller) may include any one or more of a microprocessor, a digital signal processor (DSP), an application specific integrated circuit (ASIC), a field program gate array (FPGA), or equivalent discrete or integrated logic circuitry. In some example embodiments, processing unit 102 may include multiple components, such as any combination of one or more microprocessors, one or more controllers, one or more DSPs, one or more ASICs, one or more FPGAs, as well as other discrete or integrated logic circuitry. In one embodiment, the processing unit 102 is a communication management unit (CMU) or other controller already implemented in the vehicle.

The functions attributed to processing unit 102 herein may be embodied as software, firmware, hardware or any combination thereof. Memory 104 may include computer-readable instructions that, when executed by the processing unit 102 provide functions of the processing unit 102. Such functions may include location functions 106 and region information functions 108 as discussed in detail below. The computer readable instructions may be encoded within the memory 104. Memory 104 may comprise computer readable storage media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium.

In an embodiment, the vehicle travel information system 100 further includes databases 110-1 through 110-n. The Databases 110-1 through 110-n can generally be references as 110. Databases 110 may comprise computer readable storage media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium. The databases contain information relating to regions “region information” the vehicle may travel through. In one embodiment, the databases 110 are CMU or communication management function (CMF) databases already used in the vehicle. In one embodiment, the databases 110 are data loaded. Also included in the vehicle travel information system 100 is a communication system 112 that is in communication with the processing unit 102. In one embodiment, updates to the at least one database 110 are received through the communication system 112. Further in one embodiment, an uplink communication through the communication system 112 while the vehicle is traveling is used to configure settings in the at least one database 110. In other embodiments at least one of the databases 110 is a static database. Further in another embodiment the region information is hardcoded in software.

A user interface 114 is further in communication with the processing unit 102. The processing unit 102 uses the user interface 114 to provide messages to the operator of the vehicle based on a then current location of the vehicle in an embodiment. In one embodiment, the user interface 114 is a multifunctional display (MFD). Further in an embodiment, the vehicle travel information system 100 may include a vehicle control 115 that controls the operation of the vehicle on direction of the processing unit 102 based on a then current location of the vehicle. For example, if it is determined a current location (region an aircraft is passing through) requires a minimum altitude, the processing unit will direct the vehicle control 115 to adjust the altitude (after clearance) if needed as well as indicate to the operator through the user interface 114 that the region requires the minimum altitude. Further in an embodiment, a clearance request is at least in part generated based on implemented region information instructions.

The vehicle travel information system 100 further includes a plurality of sensors to gather sensor information. The sensors illustrated in FIG. 1, includes a location sensor 116, a speed sensor 118, an altitude sensor as well sensor 122. Sensor 122 may be any other type of sensor needed for operation of the vehicle. The location sensor 116, may be part of a vehicle location system such as a global satellite based navigation system, radar system or the like that provides location information of the vehicle. Further location information may be uplinked to the processing unit 102 through the communication system 112 from a remote station, such as but not limited to, a ground station.

The processing unit 102 in embodiments compares the current location information of the vehicle to regions stored in the databases 110. If it is determined that the current location of the vehicle is associated with a region that includes region information, the region information is passed on to the user interface 114. The processing unit 102 continues monitoring the location of the vehicle throughout the travel path and determining if current locations are associated with regions with region information. In one embodiment, it is determined if the vehicle is about to pass into a region with region information. This embodiment provides notice before a region is entered of region information so the operator and/or vehicle has time to react before the region is entered. In one embodiment this is done with the processor unit 102 estimating when a region is to be entered based at least on a current travel path, current speed, acceleration etc. of the vehicle.

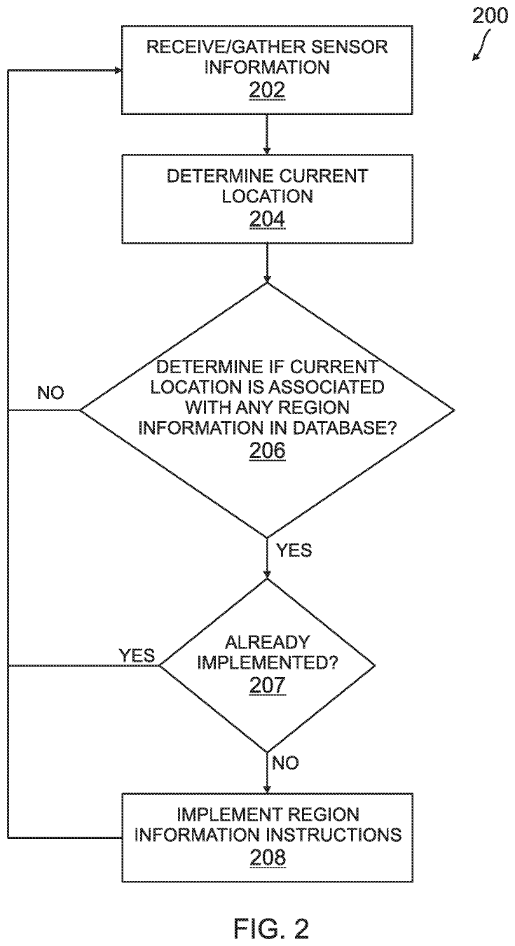

FIG. 2 illustrates an information generating flow diagram 200 of an example embodiments. The information generating flow diagram 200 is provided as a series of steps or blocks. The sequential order of the steps in the information generating flow diagram 200 may be different in other embodiments. Hence, embodiments are not limited to the sequence of steps provided in FIG. 2.

In the example of FIG. 2, the process starts by receiving and gathering sensor information at step (202). As discussed above, the sensor information may provide information needed for safe operation of the vehicle. Further the sensor information in an example is used to determine the current location at step (204) as well as determine other aspects of the vehicle such as, but not limited to, speed, altitude, acceleration and bearing. As discussed, at step (204) the current location of the vehicle is determined. The determination may be based on the received/gather information from the sensors or may be provided remotely to the vehicle from a remote station (location) or a combination of both.

Once the current location is determined at (204), it is determined if the current location is associated in with any regions in one of databases 110 that includes region information at step (206). The current location may be associated with a region if it is located in the region or, in one embodiment, is expected to enter the region in the near future based on at least one of travel path, current speed, acceleration, attitude, wind speed etc. If it is determined at step (206) that the current location is not associated with a region with region information, the process continues at step (202) receiving and gathering sensor information. If, however, it is determined at step (206) that the current location is associated with a region with region information, it is then determined if the instruction have been already been implement at step (207) in an embodiment. If they have already been implemented, the process continues at step (202). If it is determined at step (207) that the instructions have not been implemented, the associated region information instructions are implemented at step (208) and the process continues at step (202). Including step (207) prevents the implementation of the region information over and over again while in its associated region or about to enter an associated region. In another embodiment, step (207) may be configured to allow the implementation of the region information a select number of times while in or about to enter an associated region.

Implementing region information instructions may include implementing alert instructions, report generation instructions, selection instructions, feature instructions and restrictions instructions. Examples of regional information include speed limits, altitude limits, vehicle restraints, restricted travel areas, region specific regulations, enable vehicle features, disable vehicle features, request to send vehicle position report and auto connect of preferred vehicle controller.

Further specific examples where on board database driven message system may be of benefit in an avionic setting include, reminding a pilot when entering a countries airspace of specific rules or restrictions. For Example, on entering Europe airspace, alerting the pilot to check if the aircraft has been logged on to the Protected Mode—Controller Pilot Datalink Communication (PM-CPDLC) used in the Europe. Another example, is sending a positon report due to a flight information region (FIR) based on a region change. Also discussed above, the database driven message maybe used to enable and disable features. For example, a positon report system may be shutoff when entering a region when a very important person (VIP) is onboard or it may switch between Aeronautical Telecommunication Network (ATN) and Future Air Navigation System (FANS) communications based on entering a region. Further embodiments may be used to set an interval in which positon report messages are sent based on the region the aircraft is flying over (i.e. terrestrial/ocean).

### EXAMPLE EMBODIMENTS

Example 1 is a vehicle travel information system that includes at least one vehicle location system and at least one processor unit. The at least one vehicle location system is configured to generate vehicle location information. The at least one processor unit is in communication with the at least one vehicle location system. The at least one processer unit is configured to implement instructions to monitor the location information provided by the at least one vehicle location system to determine when the vehicle has at least one of entered a travel region and is about to enter a travel region with associated region information, the at least one processor unit further configured to implement region information instructions associated with the region information when the vehicle has at least one of entered a travel region and is about to enter a travel region with the associated region information wherein implementing region information instructions includes implementing at least one of alert instructions, report generation instructions, selection instructions, feature instructions and restriction instructions.

Example 2, includes the vehicle travel information system of Example 1, wherein each travel region is defined by at least one of latitude and longitude boundaries and altitudes.

Example 3 includes the vehicle travel information system of any of the Examples 1-2, wherein the region information includes at least one of speed limits, altitude limits, vehicle restraints, restricted travel areas, region specific regulations, enable vehicle features, disable vehicle features, request to send vehicle position report and auto connect of preferred vehicle controller.

Example 4 includes the vehicle travel information system of any of the Examples 1-3, wherein the region information is stored in at least one database.

Example 5 includes the vehicle travel information system of any of the Examples 1-4, further including a communication system that is in communication with the at least one processor unit. The communication system is configured to provide communications between the at least one processor and remote stations.

Example 6 includes the vehicle travel information system of Examples 5, wherein the communication system is configured to pass uplink updates regarding the region information.

Example 7 includes the vehicle travel information system of any of the Examples 1-6, further including a vehicle control in communication with the at least one processor. The at least one processor unit is configured to control the vehicle control based at least in part on implemented region information instructions.

Example 8 includes the vehicle travel information system of any of the Examples 1-7, wherein the at least one vehicle location system further includes at least one sensor that is configured to gather data used to generate the vehicle location information.

Example 9 includes the vehicle travel information system of any of the Examples 1-8, wherein the at least one vehicle location system is configured to generate the vehicle location information based at least in part from information communicated from a remote location.

Example 10 is a vehicle travel information system including at least one database, at least one vehicle location system, a vehicle user interface and at least one processor unit. The least one database contains region information. The at least one vehicle location system is configured to generate vehicle location information. The least one processor unit is in communication with the at least one database, the at least one vehicle location system and vehicle user interface. The at least one processer unit is configured to implement instructions to monitor the location information provided by the at least one vehicle location system to determine when the vehicle has at least one of entered a travel region with associated region information and is about to enter a travel region with associated region information, the at least one processor unit further configured to implement the associated region information when the vehicle has at least one of entered the travel region with the associated region information and is about to enter the travel region with the associated region information to implement at least one of alert instructions, report generation instructions, selection instructions, feature instructions and restriction instructions, the at least one processer further configured to convey the region information via the vehicle user interface.

Example 11 includes the vehicle travel information system of Examples 10, further including a communication system and vehicle control. The communication system is in communication with the at least one processor unit. The communication system is configured to provide communications between the at least one processor unit and remote stations. The communication system is further configured to pass uplink updates to the at least one database. The vehicle control is used to control at least one operation of the vehicle. The at least one processor unit is in communication with the vehicle control to activate the vehicle control based at least in part on the implantation of the region information instructions.

Example 12 includes the vehicle travel information system of any of the Examples 10-11, wherein the at least one vehicle location system generates vehicle location information based off of at least one of a location sensor and a remote location signal.

Example 13 includes the vehicle travel information system of any of the Examples 10-12, wherein the region information includes at least one of speed limits, altitude limits, vehicle restraints, restricted travel areas, region specific regulations, enable vehicle features, disable vehicle features, request to send vehicle position report and auto connect of preferred vehicle controller.

Example 14 is a method of generating vehicle travel information. The method includes monitoring the current location of the vehicle; based on at least one of the current location of the vehicle in a region and an anticipated location of the vehicle in a region in a near future, determining if at least one of the current location and the anticipated location of the vehicle is associated with a region that has associated region information stored in at least one database; and when it is determined that at least one of the current location and the anticipated location of the vehicle is associated with a region that has associated region information stored in the at least one database, implementing the associated region information to implement at least one of alert instructions, report generation instructions, selection instructions, feature instructions and restriction instructions.

Example 15 includes the method of the Example 14, wherein each travel region is defined by at least one of latitude and longitude boundaries and altitudes.

Example 16 includes the method of any of the Examples 14-15, further including updating the region information in the at least one database through at least one of data loaded and a communication uplink.

Example 17 includes the method of any of the Examples 14-16, further including controlling operation of the vehicle based at least in part on the implemented region information.

Example 18 includes the method of any of the Examples 14-17, further including when it is determined that at least one of the current location and the anticipated location of the vehicle is not associated with a region that has associated region information stored in the at least one database, continuing to monitor the current location of the vehicle.

Example 19 includes the method of any of the Examples 14-18, wherein the region information includes at least one of speed limits, altitude limits, vehicle restraints, restricted travel areas, region specific regulations, enable vehicle features, disable vehicle features, request to send vehicle position report and auto connect of preferred vehicle controller.

Example 20 includes the method of any of the Examples 14-19, wherein the region information relates to a vehicle position report system that directs the vehicle to at least one of enable the vehicle position report system, disabling the vehicle position report system and setting an interval in generating a position communication in the vehicle position report system.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A vehicle travel information system comprising:
at least one vehicle location system configured to generate vehicle location information;
at least one processor unit in communication with the at least one vehicle location system, the at least one processer unit configured to implement instructions to monitor the location information provided by the at least one vehicle location system to determine when the vehicle has at least one of entered a travel region and is about to enter a travel region with associated region information, the at least one processor unit further configured to implement region information instructions associated with the region information when the vehicle has at least one of entered a travel region and is about to enter a travel region with the associated region information; and
wherein implementing region information instructions includes implementing at least one of alert instructions, report generation instructions, selection instructions, feature instructions and restriction instructions.

2. The vehicle travel information system of claim 1, wherein each travel region is defined by at least one of latitude and longitude boundaries and altitudes.

3. The vehicle travel information system of claim 1, wherein the region information includes at least one of speed limits, altitude limits, vehicle restraints, restricted travel areas, region specific regulations, enable vehicle features, disable vehicle features, request to send vehicle position report and auto connect of preferred vehicle controller.

4. The vehicle travel information system of claim 1, wherein the associated region information is stored in at least one database.

5. The vehicle travel information system of claim 1, further comprising:
a communication system in communication with the at least one processor unit, the communication system configured provide communications between the at least one processor and remote stations.

6. The vehicle travel information system of claim 5, wherein the communication system is configured to pass uplink updates relating to the region information.

7. The vehicle travel information system of claim 1, further comprising:
a vehicle control in communication with the at least one processor, the at least one processor unit configured to control the vehicle control based at least in part on implemented region information instructions.

8. The vehicle travel information system of claim 1, wherein the at least one vehicle location system further comprising:
at least one sensor configured to gather data used to generate the vehicle location information.

9. The vehicle travel information system of claim 1, wherein the at least one vehicle location system is configured to generate the vehicle location information based at least in part from information communicated from a remote location.

10. A vehicle travel information system comprising:
at least one database containing region information;
at least one vehicle location system configured to generate vehicle location information;
a vehicle user interface;
at least one processor unit in communication with the at least one database, the at least one vehicle location system and vehicle user interface, the at least one processer unit configured to implement instructions to monitor the location information provided by the at least one vehicle location system to determine when the vehicle has at least one of entered a travel region with associated region information and is about to enter a travel region with associated region information, the at least one processor unit further configured to implement the associated region information when the vehicle has at least one of entered the travel region with the associated region information and is about to enter the travel region with the associated region information to implement at least one of alert instructions, report generation instructions, selection instructions, feature instructions and restriction instructions, the at least one processer further configured to convey the region information via the vehicle user interface.

11. The vehicle travel information system of claim 10, further comprising:
a communication system in communication with the at least one processor unit, the communication system configured to provide communications between the at least one processor unit and remote stations, the communication system is configured to pass uplink updates to the at least one database; and
a vehicle control to control at least one operation of the vehicle, the at least one processor in communication with the vehicle control to activate the vehicle control based at least in part on the implantation of the region information instructions.

12. The vehicle of claim 11, wherein the at least one vehicle location system generates vehicle location information based off of at least one of a location sensor and a remote location signal.

13. The vehicle of claim 10, wherein the region information includes at least one of speed limits, altitude limits, vehicle restraints, restricted travel areas, region specific regulations, enable vehicle features, disable vehicle features, request to send vehicle position report and auto connect of preferred vehicle controller.

14. A method of generating vehicle travel information, the method comprising:
monitoring the current location of the vehicle;
based on at least one of the current location of the vehicle in a region and an anticipated location of the vehicle in a region in a near future, determining if at least one of the current location and the anticipated location of the vehicle is associated with a region that has associated region information stored in at least one database; and
when it is determined that at least one of the current location and the anticipated location of the vehicle is associated with a region that has associated region information stored in the at least one database, implementing the associated region information to implement at least one of alert instructions, report generation instructions, selection instructions, feature instructions and restriction instructions.

15. The method of claim 14, wherein each travel region is defined by at least one of latitude and longitude boundaries and altitudes.

16. The method of claim 14, further comprising:
updating the region information in the at least one database through at least one of data loaded and a communication uplink.

17. The method of claim 14, further comprising:
controlling operation of the vehicle based at least in part on the implemented region information.

18. The method of claim 14, further comprising:
when it is determined that at least one of the current location and the anticipated location of the vehicle is not associated with a region that has associated region information stored in the at least one database, continuing to monitor the current location of the vehicle.

19. The method of claim 14, wherein the region information includes at least one of speed limits, altitude limits, vehicle restraints, restricted travel areas, region specific regulations, enable vehicle features, disable vehicle features, request to send vehicle position report and auto connect of preferred vehicle controller.

20. The method of claim 14, wherein the region information relates to a vehicle position report system that directs the vehicle to at least one of enable the vehicle position report system, disabling the vehicle position report system and setting an interval in generating a position communication in the vehicle position report system.
